(19) United States
(12) Patent Application Publication
(10) Pub. No.: US 2002/0103734 A1
(43) Pub. Date: Aug. 1, 2002

(54) Method and apparatus for managing publication and sharing of data

(76) Inventors: David H.J. Glassco, Surrey (CA); Martin M. Lacey, Surrey (CA); Owen D. Walsh, Vancouver (CA); Pavel Vasak, North Vancouver (CA)

Correspondence Address: COLUMBIA IP LAW GROUP, PC, 10260 SW GREENBURG ROAD, SUITE 820, PORTLAND, OR, 97223, US

(21) Appl. No.: 09/771,515

(22) Filed: Jan. 27, 2001

(51) Int. Cl. G06F 7/00; G06F 17/30; G06F 17/60

(52) U.S. Cl. 705/35

(57) ABSTRACT

A first user is designated as an eligible shared data contributor. An authorized service component of the eligible shared data contributor is designated as a shared data publishing component. A data publication is defined. The eligible shared data contributor tags data managed by said publishing component for inclusion with the data publication. A second user is designated as an eligible shared data subscriber. The second user is associated as a subscriber of the data publication. The first user contributes to the data managed by the publishing component, and the second user is allowed access to the data managed by the publishing component based on the second user's subscription to the data publication. The first and second users may or may not be of the same licensee organization, thereby allowing intra as well as extra-organizational sharing of data.

### BACKGROUND OF THE INVENTION

1. Field of the Invention

The present invention relates to the field of electronic data/information processing. More specifically, the present invention relates to methods and apparatuses for managing contribution to and usage of shared data.

2. Background Information

Typically, user access to applications and data are controlled through user logons and user profiles administered by system administrators. Users are required to logon to individual application and/or file servers. Once logged on to an application/file server, a user's access authority to applications and/or data on the server is governed by the user's profile created and maintained by a system administrator. For example, if a system administrator has classified the user as a privileged user, as opposed to an unprivileged user, the control software of the server (e.g. the file subsystem, or the operating system itself) allows the user certain creation or deletion authority otherwise not available to other users classified as unprivileged users. On file servers, individual users may exercise further control or protection by e.g. password protecting or encrypting their own data, and controlling effective access and/or usage of these further protected data by controlling the distribution and sharing of the passwords and/or decryption keys.

With the advance of telecommunication and networking technology, and the availability of public data networks, such as the Internet, increasingly users are “interconnected” together, and applications as well as data need to be shared in a controlled manner among a very large set of user population with very different access needs. These earlier described log-on and system administrator administered user profile based prior art approaches are no longer able to provide the control with the desired flexibility and ease of administration. The problem is further compounded with function rich applications or hosted applications (commonly known as application services), such as the financial applications or application services available from FinancialCAD of Surrey, Canada, assignee of the present application, where user accesses and licensing are flexibly administered at a function offering or service level. Thus, a new approach to managing and administering contribution to and usage of shared data is desired.

### SUMMARY OF THE INVENTION

A first user is designated as an eligible shared data contributor. An authorized service component of the eligible shared data contributor is designated as a shared data publishing component. A data publication is defined. The eligible shared data contributor tags data managed by the publishing component for inclusion in the data publication. A second user is designated as an eligible shared data subscriber. The second user is associated as a subscriber of the data publication. The first user contributes to the data managed by the publishing component, and the second user is allowed access to the data managed by the publishing component based on the second user's subscription to the data publication. The first and second users may or may not be of the same licensee organization, thereby allowing intra as well as extra-organizational sharing of data.

Additionally, in accordance with another aspect, a third user selectively authorizes members of a number of data sharing entities to invoke methods of a service component. During operation, a fourth user is conditionally permitted to invoke one of the methods in accordance with whether the fourth user as a member of one of the data sharing entities is authorized to invoke the method.

In one embodiment, the data sharing entities include the data contributor himself/herself, his/her user group, his/her organization, his/her enterprise, and an universal data sharing entity.

In one embodiment, the methods include one or more of invoking a method to obtain data, invoking a method to store data, and invoking a method to perform a predetermined execution using at least the data managed by the component.

In one embodiment, the authorizations given to the members of the data sharing entities are encoded into a single value and assigned to a security property of the component, which is checked during operation to determine whether the fourth user is to be permitted to invoke the method.

In one embodiment, the service component is part of a package user to form a service, which in turn is used to form a function offering of an application or application service.

### BRIEF DESCRIPTION OF DRAWINGS

The present invention will be described by way of exemplary embodiments, but not limitations, illustrated in the accompanying drawings in which like references denote similar elements, and in which:

The present invention will be described by way of exemplary embodiments, but not limitations, illustrated in the accompanying drawings in which like references denote similar elements, and in which:

FIG. 1 illustrates an overview of the present invention, in accordance with one embodiment;

FIG. 2 illustrates the relationship between the various entities of the present invention, including the account creation and administration method of the present invention, in accordance with one embodiment;

FIGS. 3a-3b illustrate a data organization of the administrator/user account creation and management tool, in accordance with one embodiment;

FIGS. 3c-3d illustrate properties and methods of a component object under the present invention, in particular, the security attribute, in accordance with one embodiment;

FIG. 4 illustrates an end user interface of the administrator/user account creation and management tool, in accordance with one embodiment;

FIG. 5 illustrates the relevant operational flow of the administrator/user account creation and management tool, in accordance with one embodiment;

FIG. 6 illustrates a function offering/service creation and authorizing method of the present invention, in accordance with one embodiment;

FIGS. 7a-7b illustrate a data organization of the function offering/service creation and management tool, in accordance with one embodiment;

FIGS. 8a-8d illustrate an end user interface of the function offering/service creation and management tool, in accordance with one embodiment;

FIGS. 9a-9d illustrate the relevant operational flows of the function offering/service creation and management tool, in accordance with one embodiment;

FIG. 10 illustrates an overview of the function offering/service execution method of the present invention, in accordance with one embodiment;

FIG. 11 illustrates the relevant operational flow of the runtime controller of FIG. 10, in accordance with one embodiment;

FIG. 12 illustrates a network environment suitable for practicing the present invention, in accordance with one embodiment; and

FIG. 13 illustrates an example computer system suitable for use as one of the administrator/user computer of FIG. 12 to practice the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented using terms such as accounts, IDs, objects, end-user interfaces, buttons, and so forth, commonly employed by those skilled in the art to convey the substance of their work to others skilled in the art. Parts of the description will be presented in terms of operations performed by a computer system, using terms such as creating, authorizing, publication, subscribing, and so forth. As well understood by those skilled in the art, these quantities and operations take the form of electrical, magnetic, or optical signals capable of being stored, transferred, combined, and otherwise manipulated through mechanical and electrical components of a digital system; and the term digital system include general purpose as well as special purpose data processing machines, systems, and the like, that are standalone, adjunct or embedded.

Various operations will be described as multiple discrete steps performed in turn in a manner that is most helpful in understanding the present invention, however, the order of description should not be construed as to imply that these operations are necessarily order dependent, in particular, the order the steps are presented. Furthermore, the phrase “in one embodiment” will be used repeatedly, however the phrase does not necessarily refer to the same embodiment, although it may.

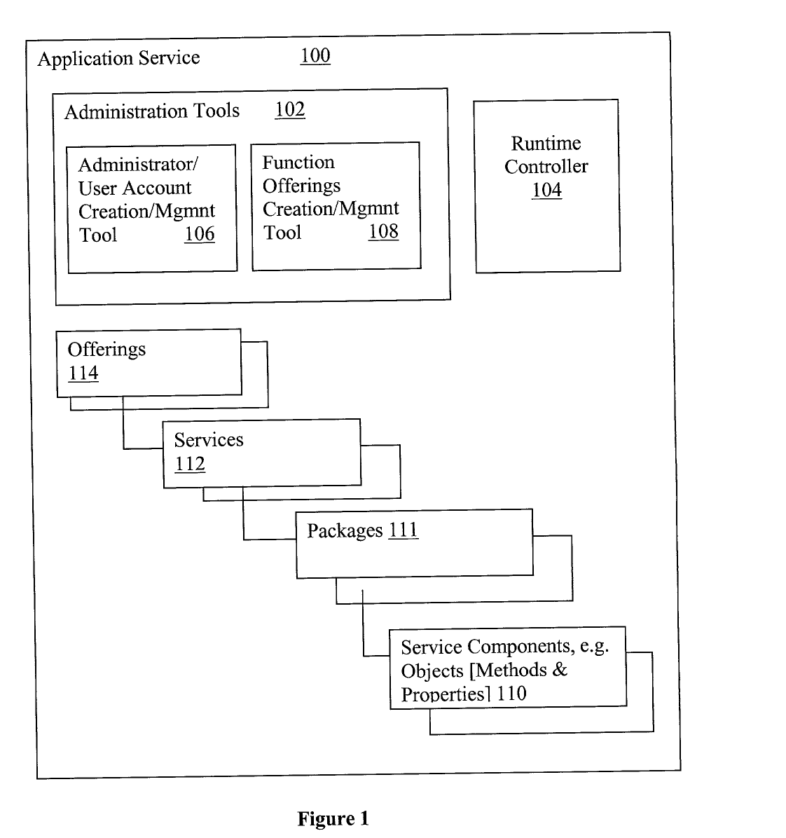

Referring now to FIG. 1, wherein an overview of the present invention in accordance with one embodiment is shown. As illustrated, in accordance with the present invention, Application or application service 100 (hereinafter, including the claims, simply application) having a number of service components 110 (or simply components) is provided with administration tools 102 and runtime controller 104 to facilitate administration and management of user access and usage of components 110. In one embodiment, application 100 is hosted on one or more servers, and the users are remote client users accessing components 110 remotely.

For the illustrated embodiment, as will be described in more details below, components 110 are selectively packaged into packages 111, which in turn are packaged into services 112, and then function offerings 114 for administration and management, i.e. licensing and access/usage control. However, as will be apparent from the description to follow, the present invention may alternatively be practiced with more or less levels of organization/packaging of components 110.

For the purpose of this application, components are programmatic software entities commonly referred to as “objects”, having methods and properties, as these terms are well known in the context of object oriented programming. Packages are groupings of interdependent components similar in functional scope. Services are logical groupings of service functionality that when combined with other services provide broader information processing support. Functional offerings are sets of services offered and licensed to licensees.

Administration tools 104 include in particular administrator/user account creation/management (ACM) tool 106 and function offering/service creation/management (FCM) tool 108. Briefly, ACM tool 106 is equipped to facilitate creation of various administrator and end user accounts for various administrators and end users, including facilitation of empowerment of various administrators to administer control on user access to application 100, more specifically, functional offerings 114 and services 112. FCM tool 106 is equipped to facilitate creation of the various function offerings 114 and services 112, including empowering of the various administrators in administering control on user access to components 110, through invocation of function offerings 114 and/or services 112. These and other aspects of the present invention will be described in turn in the description to follow.

Before proceeding with additional description, it should be noted that application 100 is intended to represent a broad range of application known in the art, including in particular financial applications such as those offered by the assignee of the present invention. Further, while for ease of understanding, the present invention is presented in the context of application 100, from the description to follow, those skilled in the art would appreciate that the present invention may be practiced for other system/subsystem software products or services, as well as other multi-media contents, including but not limited to video, audio and graphics. Accordingly, unless specifically limited, the term “application” as used herein in this patent application, including the specification and the claims, is intended to include system and subsystem software products and services, as well as multi-media contents.

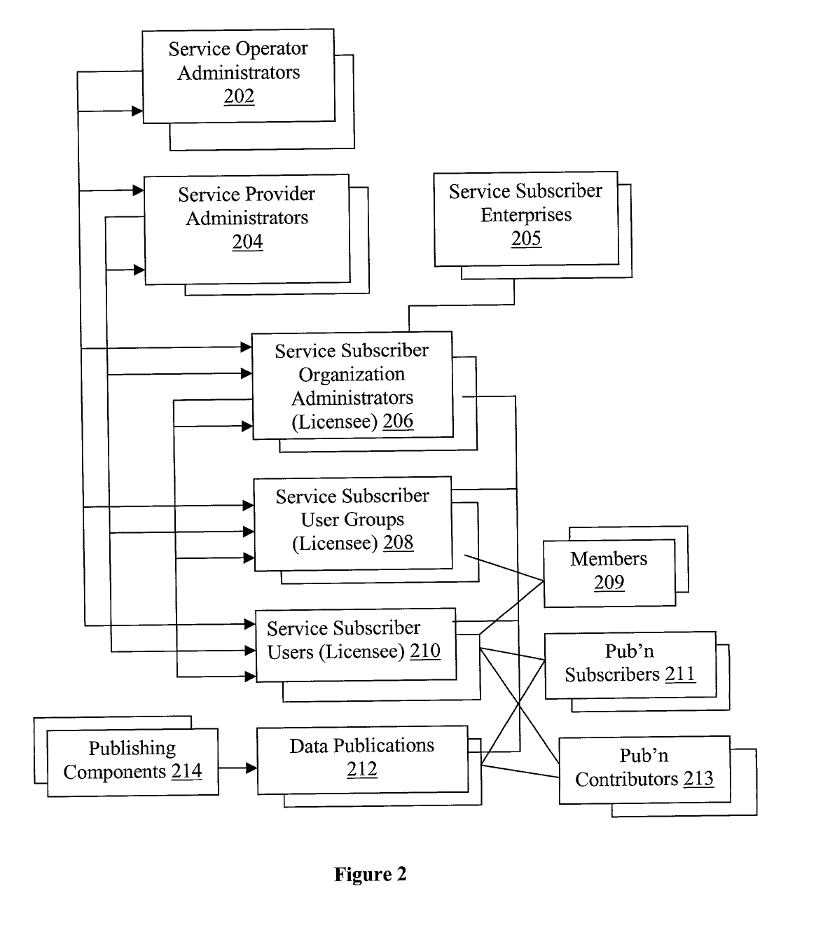

Referring now to FIG. 2, wherein an overview of the relationship between the various entities under the present invention, including the administrator and user account creation and management method of the present invention, in accordance with one embodiment, is shown. As illustrated, for the embodiment, an administrator 202 of a service operator creates administrator accounts for administrators of service providers 204. An empowered administrator 202 may also create administrator accounts for other administrators of the service operator. Administrators 202 of the service operator also empower administrators 204 of the service providers to further create other administrator and user accounts, and administer control on user access to components 110 of application 100 (through access to functional offerings 114 or services 112).

For the purpose of this application, a service operator is an organization that provides hardware, software and data management services, whereas a service provider is an organization that offers functional offerings or services of the application, utilizing the services of the service operator. Of course, in various embodiments, a service operator may also act in the role of a service provider.

Continuing to refer to FIG. 2, an empowered administrator 204 of a service provider in turn would create administrator accounts for administrators 206 of service subscription licensee organizations of the service provider. Similarly, an empowered administrator 204 may also create other administrator accounts other administrators of the service provider. An empowered administrator 204 of a service provider also empowers administrators 206 of the licensee organization to create user groups 208 and user accounts for users 210 of the respective licensee organizations, and administer control on user access to components 110 of application 100 (through access to functional offerings 114 or services 112) within the respective licensee organizations.

For the illustrated embodiments, licensee organizations are constituting organization units of service subscription licensee enterprises. Each licensee enterprise 205 may have one or more licensee organizations. The organization unit may be a wholly owned subsidiary, a division, a group, or a department. In other words, it may be any one of a number of internal business entities. Moreover, an empowered administrator 206 of a licensee organization may also create one or more user groups 208, and associates users 210 as members 209 of user groups 208. Similarly, in alternate embodiments, the present invention may also be practiced without the employment of user groups or with more levels of user organizations.

Note that an administrator is also a “user”, only a special “user”, having assumed the role or responsibility of administration. Similarly a service operator or a service provider is also an “enterprise”, only a special “enterprise”, having assumed the role or responsibilities described above for a service operator and a service provider respectively. Moreover, each service operator, as well as each service provider, may have its own “organization” administrators, user groups and users. However, for ease of understanding, the present invention will be described using these terms delineating the roles assumed by the different enterprises/users. Further, the present invention will only be described in terms of a service operator delegating and empowering a service provider, and an empowered service provider in turn delegating and empowering administrators of a service subscribing licensee organization, and so forth. Those skilled in the art would appreciate that the description applies equally to the service operator/providers own organization administrator, user groups and end users.

In one embodiment, an empowered administrator 202 of a service operator is also able to create the administrator accounts and the end user accounts of a licensee organization directly, skipping one or more of the administrators 204 of the service providers and the administrators 206 of the licensee organization. Similarly, an empowered administrator 204 of a service provider is also able to create user groups and end user accounts of a licensee organization directly, skipping administrators 206 of a licensee organization. In other words, for the illustrated embodiment, an administrator 202 of a service operator may perform all administration and management tasks an administrator 204 of a service provider of its creation as well as an administrator 206 of a licensee of the service provider may perform. An administrator 204 of a service provider may perform all administration and management tasks an administrator 206 of a licensee administrator of its creation may perform.

Thus, it can be seen from the above description, under the present invention, the administration and management of licensing, i.e. control of user access to an application, is advantageously hierarchical and decentralized, with the administration responsibilities distributed/delegated to administrators at various levels of the administration hierarchy. Experience has shown, the hierarchical decentralized or distributed approach is much more flexible, and particular suitable for administering and managing licensing of applications with complex multi-functions, to a large customer base with a large number of end users, across large wide area networks.

Still referring to FIG. 2, as illustrated, administrators 206 of each licensee organization may also create data publications 212 to facilitate data sharing. Administrators 206 first minimally define a number of data publications, e.g. their topics. Administrators 206 designate selected ones of its users 210 as eligible shared data contributors 213, and selected ones of the authorized service components of data contributors 213 as publishing components 214. Thereafter, contributors 213 selectively tags data managed by their authorized ones of publishing components 204 for inclusion with data publications 212 as desired. For the illustrated embodiment, data publications 212 are available for subscription across licensee organization boundaries. Administrators 206 further define which if any of extra-organizational data publications 212 are available for subscriptions by “eligible” users 210 of the licensee organization. Administrators 206 designate these “eligible” users 210 as publication subscribers 211. Subscribers 211 can then on their own subscribe to available data publications 212. Of course, a user may be designated as a contributor 213 as well as a subscriber 211 for the same or different data publications 212.

As will be apparent from the description to follow, the contributor, subscriber and data publication architecture of the present invention provides an efficient and flexible, yet controlled, approach to data sharing within and across organizations.

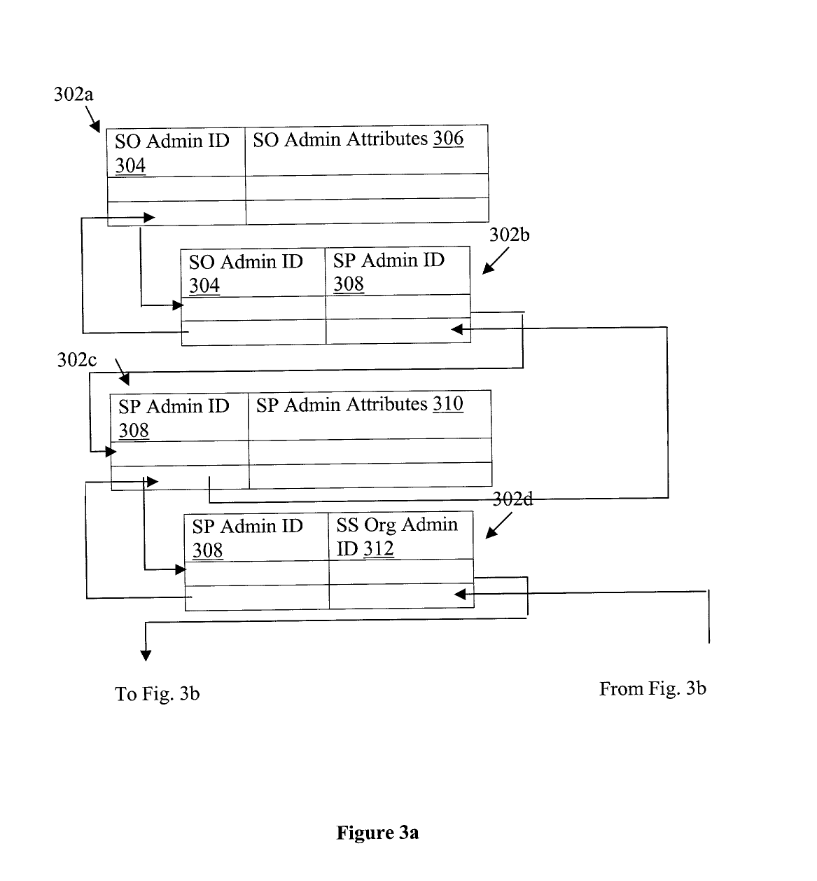

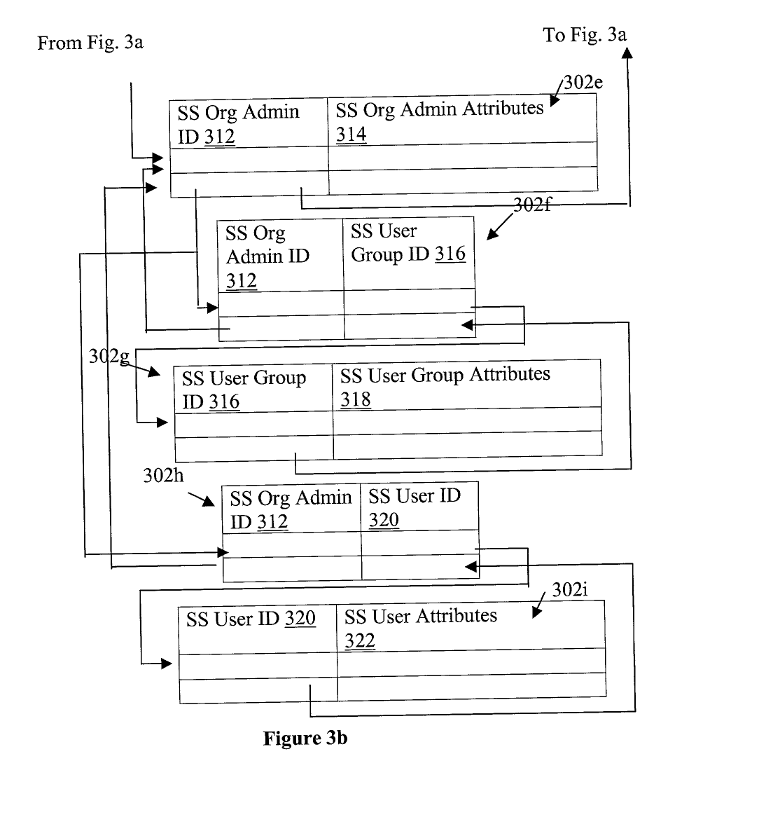

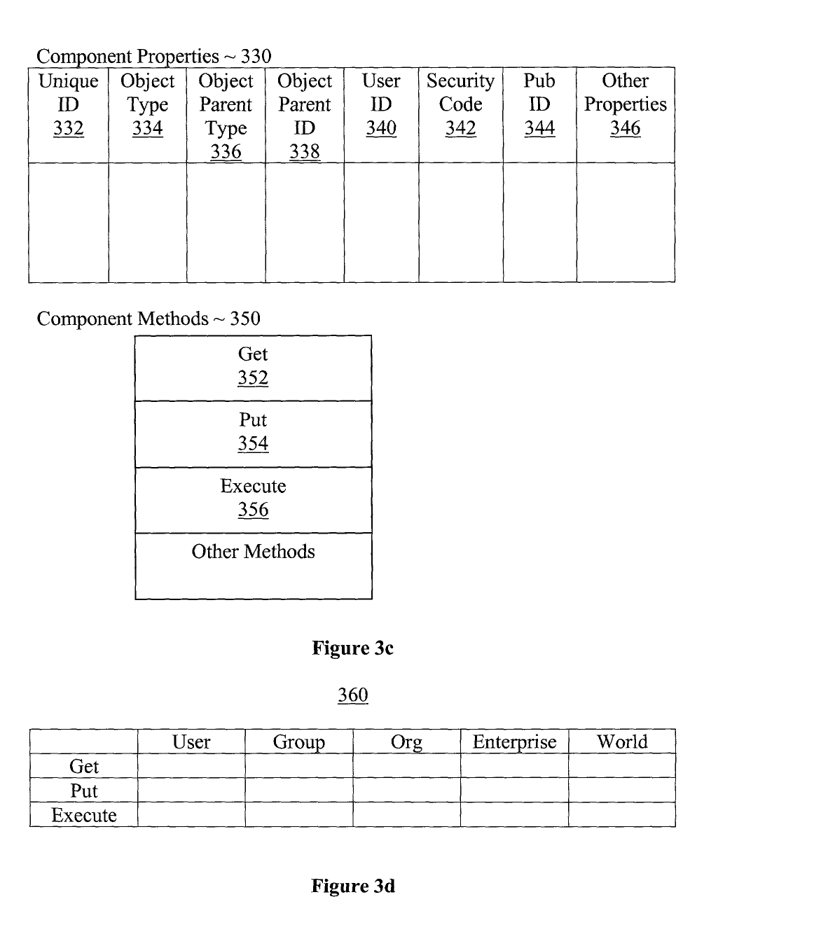

FIGS. 3a-3b illustrate a data organization associated with ACM 106 for the practice of the present invention, in accordance with one embodiment. As illustrated, data organization 300 includes tables or views 302a-302i (hereinafter, simple table or tables). Table 302a is used to store an identifier 304 and basic attribute information 306 for each administrator account of a service operator created. Identifier 304 may be formed in any manner employing any convention. Likewise, attribute information 306 may include any typical account associated information, such as the administrator's name, employee number, department number, phone number and so forth. The exact composition of these attributes is not essential to the present invention, accordingly will not be further described. Table 302b is used to store administrator account identifiers 308 for service provider administrator accounts created by the various service operator administrators denoted by administrator identifiers 304.

Table 302c is used to store an identifier 308 and basic attribute information 310 for each administrator account of a service provider created. Similarly, identifier 308 may be formed in any manner employing any convention, and attribute information 310 may include any typical account associated information. Table 302d is used to store administrator account identifiers 312 for administrator accounts of licensee organization created by the various service operator administrators denoted by administrator identifiers 308.

Table 302e is used to store an identifier 312 and basic attribute information 314 for each administrator account of a licensee organization created. Likewise identifier 312 may be formed in any manner employing any convention, and attribute information 314 may also include any typical account associated information, such as the organization administrator's name, customer number, department number, phone number and so forth. The exact composition of these attributes is also not essential to the present invention, accordingly will not be further described either. Tables 302f and 302h are used to store user group identifiers 316 and end user identifiers 320 created by the various administrators of the licensee organization denoted by organization administrator identifiers 312. Tables 302g and 302i are used to store an identifier 316 and basic attribute information 318 for each user group created, and an identifier 320 and basic attribute information 322 for each end user account created respectively. Likewise identifiers 316 and 320 may be formed in any manner employing any convention, and attribute information 318 and 322 may also include any typical account associated information, such as the user group/end user's name, customer number, department number, phone number and so forth. The exact composition of these attributes is also not essential to the present invention, accordingly will not be further described either.

As it can be seen from the description, data organization 300 enables the various types of accounts created, administrator accounts of the service operator and the service providers, administrator accounts of the licensee organizations, user groups, and end user accounts, to be easily ascertained.

In alternate embodiments, other equivalent data organizations include but not limited to flat files, hierarchical databases, linked lists, and so forth, may also be employed instead to practice the present invention.

FIGS. 3c-3d illustrate in further detail the properties of a component 110, its methods, including in particular, the security property associated with each component 110. As illustrated, for the embodiment, each component 110 includes a unique identifier 332 identifying the component, and a type property 334 to identify the object type of the component. Further, each component 110 includes properties 338 and 336 describing the parent object's identifier and the object type of the parent object respectively. Additionally, each component 110 includes property 340 identifying the user owner, property 342 identifying the access rights the user owner has granted to others, and if applicable, property 344 identifying the data publication with which the component is associated with. As illustrated, component 110 may also include other properties 346.

As alluded to earlier, each component 110 has a number of methods. For the illustrated embodiment, the methods 350 include at least a Get method 352 for retrieving data associated with the component and other applicable subscribed publishing components, a Put method 354 to store a copy of data present in the component into memory or mass storage, and an Execute method 356 to perform a pre-determined computation using the data of the component and other applicable subscribed publishing components. Of course, each component 110 may also include other methods.

As illustrated in FIG. 3d, each user owner specifies for himself/herself and other data sharing entities the rights to use these methods, i.e. the Get Method, the Put Method, and the Execute Method. If a data sharing entity is authorized to use the method, all members of the data sharing entity are authorized. In other words, authorization of the members are implicitly given. If authorized, the corresponding “cell” of “table” 360 is set to “true”, otherwise it is set to “false”, denoting the members of the data sharing entity are not authorized to use the method. For example, if a user authorizes himself/herself to use all three methods, then all three “cells” in “column” 1 of “table” 360 are set to “true” or “1”. As a further example, if other members of a group to which the user belongs to is authorized to use the Get method, then the “cell” in “column” 2, “row” 1 of “table” 360 is set to “true” or “1”, and the remaining “cells” in “column” 2, i.e. “rows” 2-3 of “table” 360 are set to “false”. The “cells” of the remaining Org, Enterprise and World columns are set accordingly. [Note that “table” 360 is employed for illustrative purpose only. The authorization data may be stored in any one of a number of known data structures.]

For the illustrated embodiment, for efficiency of storage and efficiency of processing, each digital representation of “1”s and “0”s of a combination of authorized usage of these methods for the various entities is “reduced” to a numeric value and stored in security field 342 for use during operation to control access to the data managed by the components.

In one embodiment, the reduction is performed by a secure runtime service that supports the user owner in making the authorization. Further, the reduction of the digital representation to a numeric value is made in accordance to the following approach:

a) a digital representation is determined for the authorization given to an entity (such as the user, its user group, and so forth), e.g. if the user group is authorized to Get and Execute, but not Put, the digital representation would be “101”;

b) the digital representation would be mapped to a decimal value, e.g. “001 ” would be 1, and “111” would be 7;

c) the decimal representations are then concatenated together to form the aggregated numeric representation of the authorization granted, and stored as the security property, e.g. if the decimal representations of the authorization granted to user, group, organization, enterprise and world are 7, 5, 3, 2, 0 respectively, the security property is 75320.

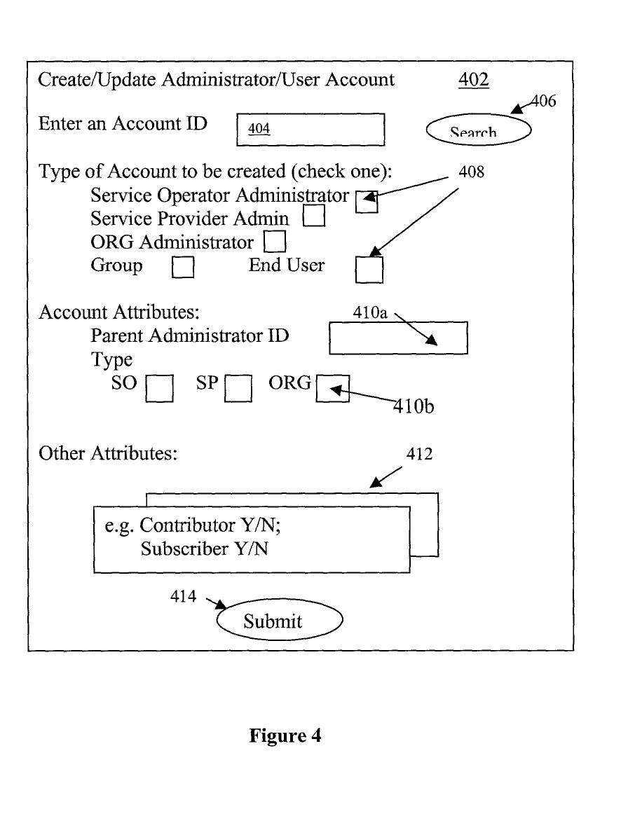

FIG. 4 illustrates an end user interface of ACM 106 suitable for use to practice the present invention, in accordance with one embodiment. For the illustrated embodiment, it is assumed that the account creating/updating administrator has successfully logged into the system (e.g. from a remote administration “console”). That is, the administrator has been properly validated as either the administrator of a service operator, one of the service provider administrators, or one of the organization administrators. Such validation may be made in any one of a number of techniques known in the art. Further, the embodiment allows any of the different accounts to be created/updated. However, as those skilled in the art will appreciate that the present invention may also be practiced with individual end user interfaces, one each of the different account types, or selective combination thereof.

For the embodiment, interface 400 includes a display 402 of the logged-in administrator's identifier. Further, it includes various check boxes 404 for the administrator to denote the account type of the account to be created. For the illustrated embodiment, selection of the account type of the account to be created also implicitly empowers the account to be created. That is, denoting the account to be created is of the service provider administrator type, implicitly empowers the account holder to be able to create and maintain organization administrator accounts, user groups as well as end user accounts. Likewise, denoting the account to be created is of the organization administrator type, implicitly empowers the account holder to be able to create and maintain user groups as well as end user accounts.

Fields 410 facilitates identification of the parent administrator for the administrator/user account being created. For example, a service provider administrator identifier is to be provided for an organization administrator account to be created, and an organization administrator identifier is to be provided for a user group or an end user account to be created. Fields 412 facilitate information entry for the various attributes of the administrator/user account to be created/updated. For the illustrated embodiment, fields 412 facilitate in particular the specification of whether the user may be designated as a contributor to contribute to data managed by a publishing component of a data publication, and whether the user may act in the role of a subscriber, subscribing to available data publications, as described earlier.

Interface 400 also includes a field 404 for reflecting the administrator/user account identifier for the account being created, or for entry of an administrator or end user identifier to retrieve the account record of the administrator/end user for update/maintenance. A “search” button 406 is also provided for the logged-in administrator to list and select the various administrator/user account records that are within the administrative scope of the logged-in administrator for update and maintenance. Button 414 submits the administrator/user account for creation or update.

In alternate embodiments, other interface features or interfaces, such as interfaces individualized for the various account types as alluded to earlier, may be used instead to practice the present invention.

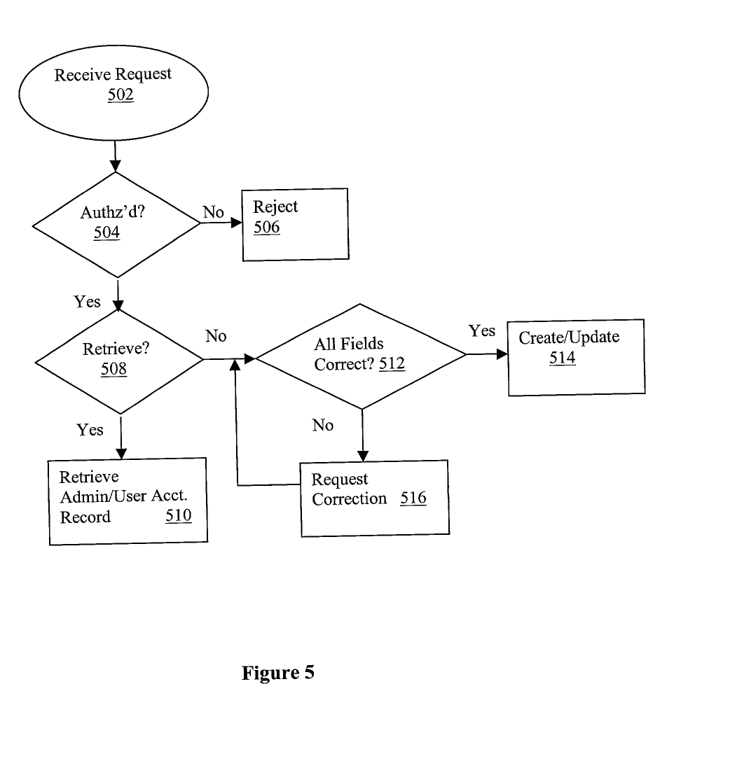

FIG. 5 illustrates the relevant operational flows of ACM 106 for practicing the present invention, in accordance with one embodiment. As illustrated, upon receipt of an event notification associated with the end user interface (hereinafter, simply “request”), ACM 106 determines if the requested operation is authorized or not, block 504, that is whether the logged-in administrator is empowered to perform the requested operation. If not, the requested operation is rejected, block 506, preferably with appropriate rejection notification messages. An example of such unauthorized operation is the request by a logged-in group administrator to create an organization administrator account.

If the requested operation is authorized, ACM 106 determines whether it is an individual record retrieval request or a “list” request, blocks 508-510. ACM 106 then either retrieves the requested individual record (using the administrator/user identifier entered), block 512, or returns a list of administrator/user identifiers that are within the administration scope of the logged-in administrator, block 514. If it is determined at block 508 that the requested operation is not a retrieval request, the requested operation is either an update or create request. ACM 106 proceeds to verify whether all required fields have been properly entered, and whether all entered fields have been entered correctly with the appropriate type of information. The precise nature of error checking is application dependent, and not essential to the practice of the present invention. If one or more errors are detected, correction is requested of the user. Eventually, upon determining that all fields are correct, ACM 106 creates or updates the administrator/user account record as requested, block 520.

Thus, the first aspect of the present invention, i.e. hierarchically and distributively administer and manage the creation of administrator and user accounts, and empowering the administrators to administer control on user access to application 100 has been described.

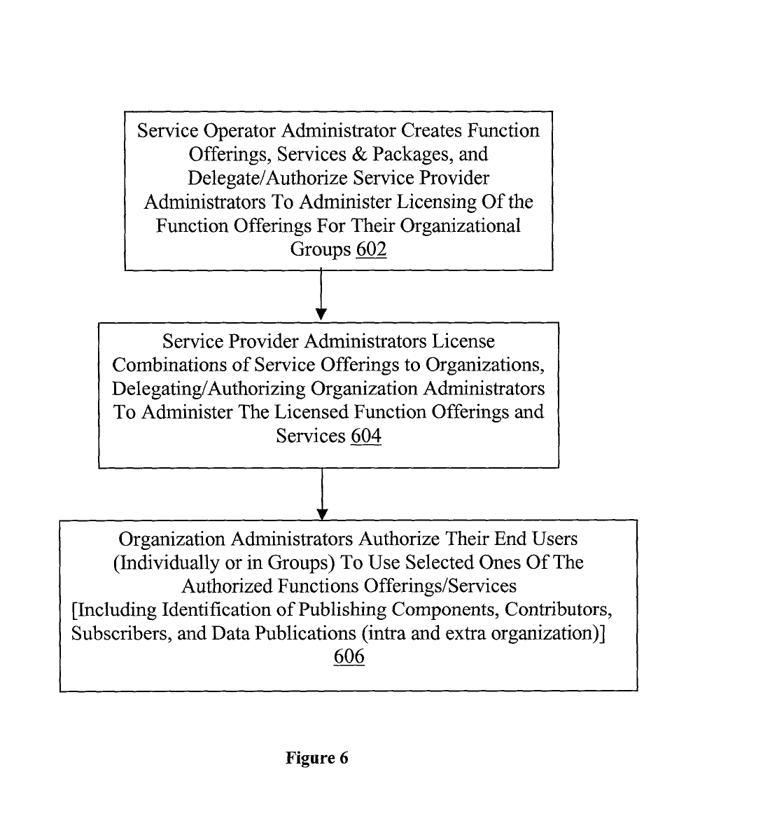

FIG. 6 illustrates the function offering/service creation and access control method of the present invention, in accordance with one embodiment. As illustrated, for the embodiment, a service operator administrator defines and creates various function offerings and services, enumerating their constituting services and service components respectively, and selectively empowers the various service provider administrators to administer control on user access to various ones of the function offerings and/or services, block 602. In turn, for the illustrated embodiment, an empowered service provider administrator selectively empowers the various organization administrators to administer control on user access to various ones of the function offerings and/or services, block 604. Then, an empowered organization administrator selectively enables members of the user groups and various end users to access various ones of the function offerings and/or services, block 606. For the illustrated embodiment, the selective enablement includes selective designation of users as contributors, authorized service components as publishing components, and definition of data publications, as well as designation of available data publications, and users as subscribers, eligible to subscribe to available data publications on their own.

Thus, it can be seen from the above description, functionalities of application 100 may be easily and flexibly defined into different function offerings and/or services for distribution and licensing to different customers, and even different organization units of a customer. Controlling access to these different function offerings and/or services may be readily effectuated through the decentralized administrators. Moreover, data may be published and shared efficiently and flexibly, yet controlled, within and across organizations.

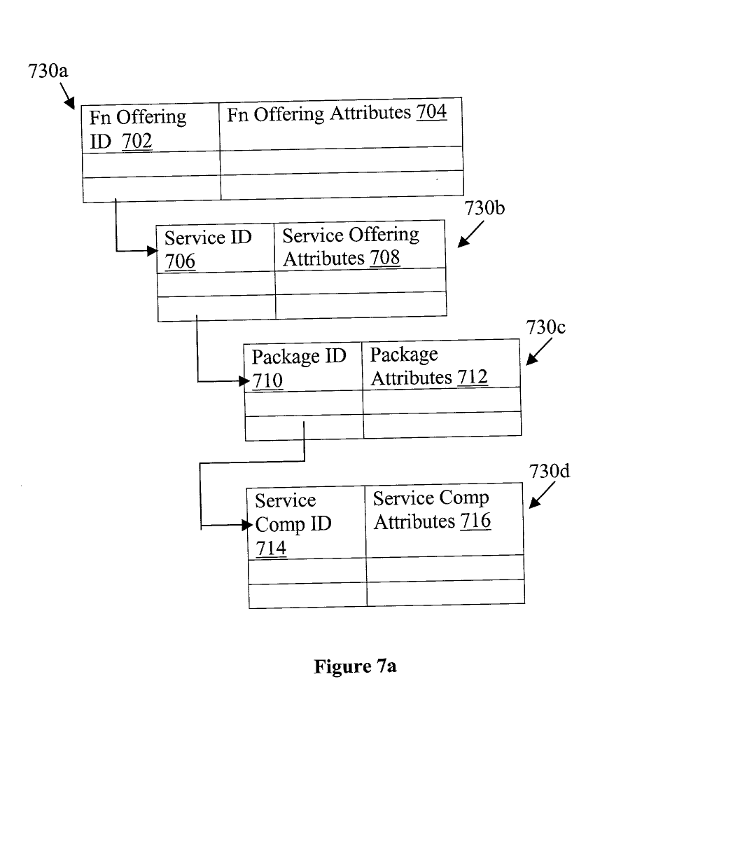

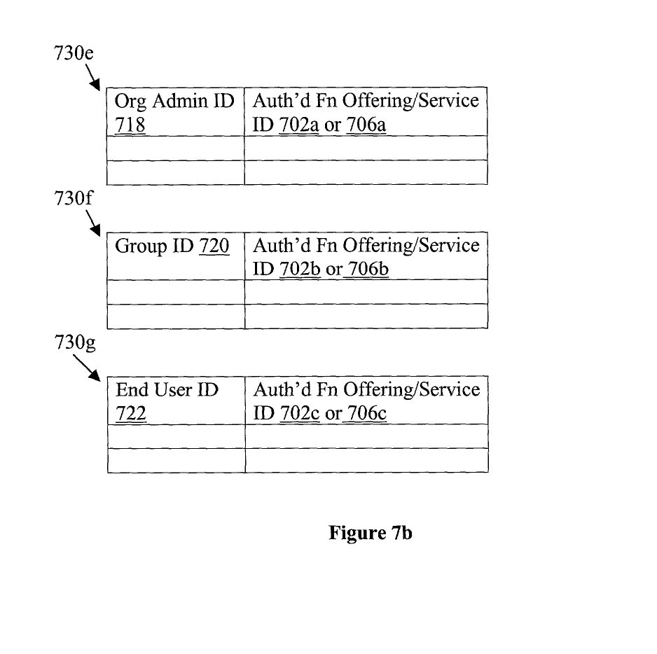

FIGS. 7a-7b illustrate a data organization associated with FCM 108 for practicing the present invention, in accordance with one embodiment. As illustrated, for the embodiment, data organization 700 includes tables/views (hereinafter simply tables) 730a-730g. Table 730a is used to store an identifier 702 and basic attribute information 704 for each function offering created. Identifier 702 may be formed in any manner, employing any convention. Attribute information 704 includes in particular pointers to the constituting services. Beyond that, attribute information 704 may include any typical offering description associated information, such as the offering's name, date of creation, date of last modification, and so forth. The exact composition of these other attributes is not essential to the present invention, accordingly will not be further described. Table 730b is used to store an identifier 706 and basic attribute information 708 for each constituting service created. Similarly, identifier 706 may be formed in any manner, employing any convention. Likewise, attribute information 708 includes in particular pointers to the constituting packages. Beyond that, attribute information 708 may include any typical service description associated information, such as the service's name, date of creation, date of last modification, and so forth. The exact composition of these other attributes is also not essential to the present invention, accordingly will not be further described either.

In like manner, table 730c is used to store an identifier 710 and basic attribute information 712 for each constituting package. Similarly, identifier 710 may be formed in any manner, employing any convention. Attribute information 712 may include any typical package description associated information, such as the package's name, date of creation, date of last modification, and so forth. The exact composition of these other attributes is also not essential to the present invention, accordingly will not be further described either. Table 720d is used to store an identifier 714 and basic attribute information 716 for each constituting service component. Similarly, identifier 714 may be formed in any manner, employing any convention. Attribute information 716 may include any typical service component description associated information, such as the service component' name, date of creation, date of last modification, and so forth, as well as those properties enumerated earlier referencing FIG. 3d. In the present context, the term “attributes” and “properties” may be considered as synonymous. The exact composition of these other attributes/properties, except for the enumerated ones, is also not essential to the present invention, accordingly will not be further described either.

Table 730e is used to store the identifiers 702a and 706a of the various function offerings and services, the various organization administrators (denoted by identifiers 718) are empowered (i.e. authorized) to administer control on their accesses. Tables 730f-730g are used to store the identifiers 702b702c and 706b-706c of the various function offerings and services, the various end users (denoted by identifiers 720-722) are enabled to access.

In alternate embodiments, these data may be organized differently. Further, different data structures may be employed to store the data.

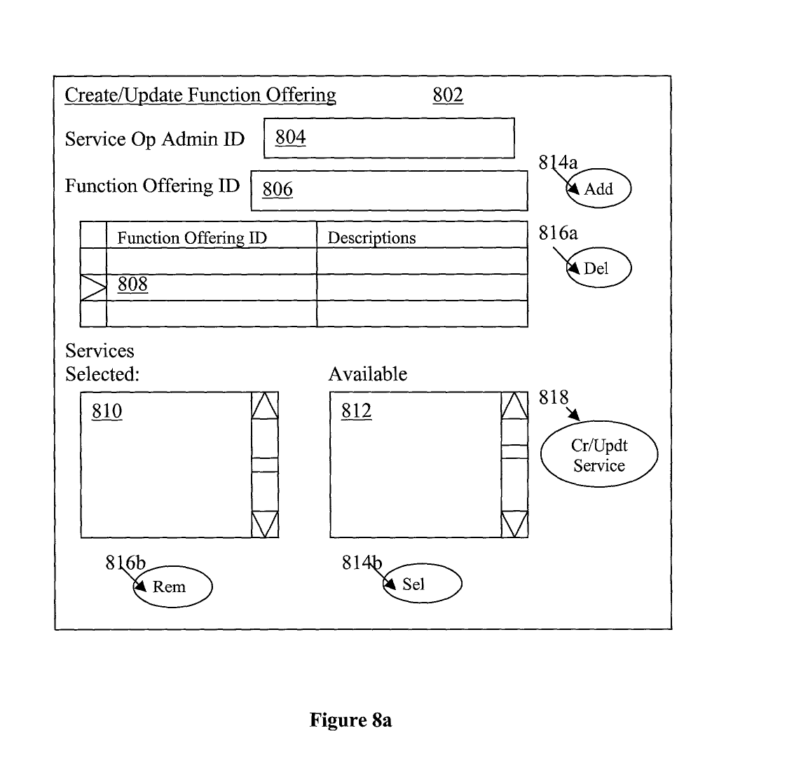

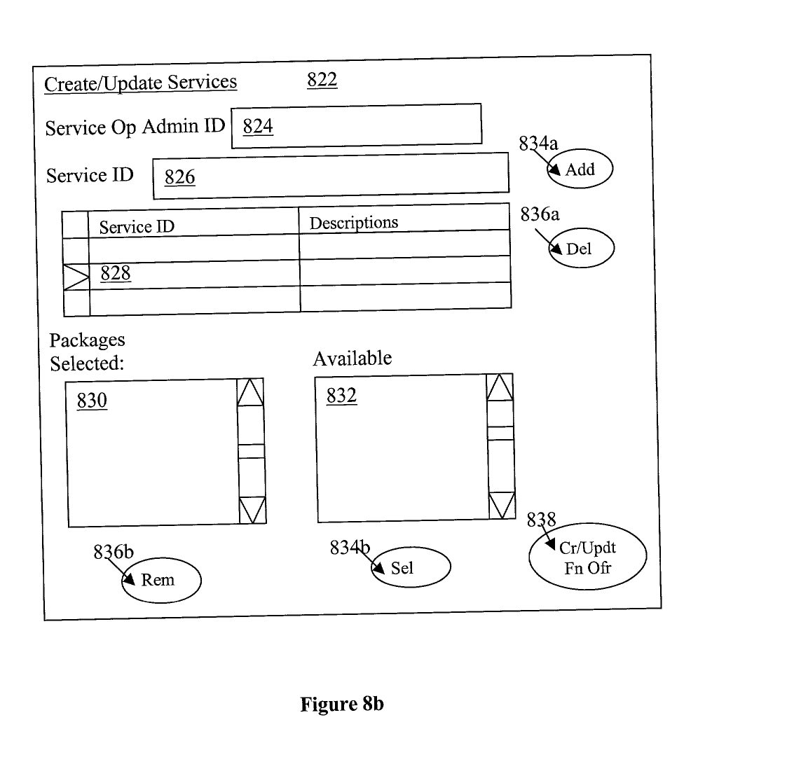

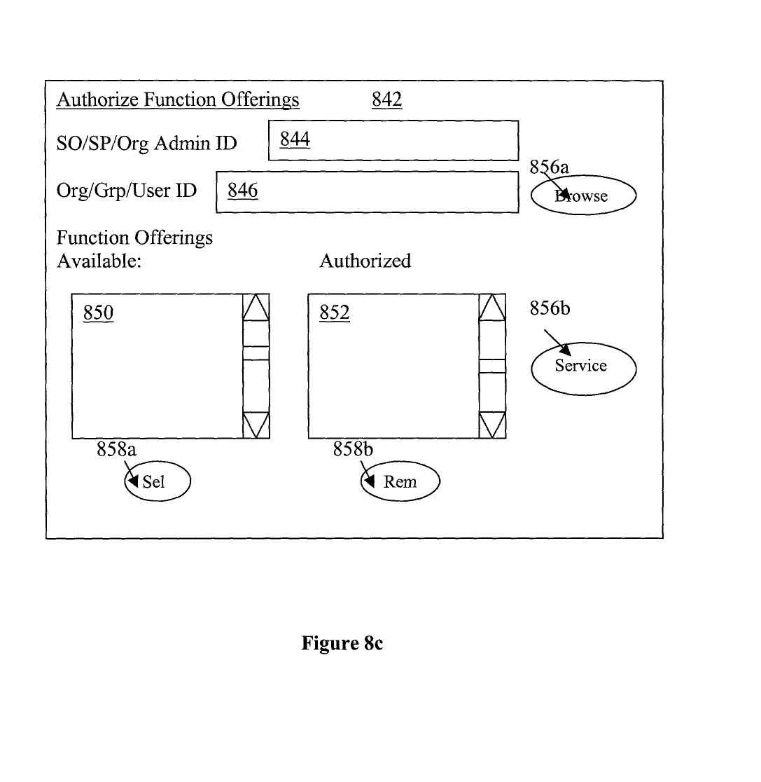

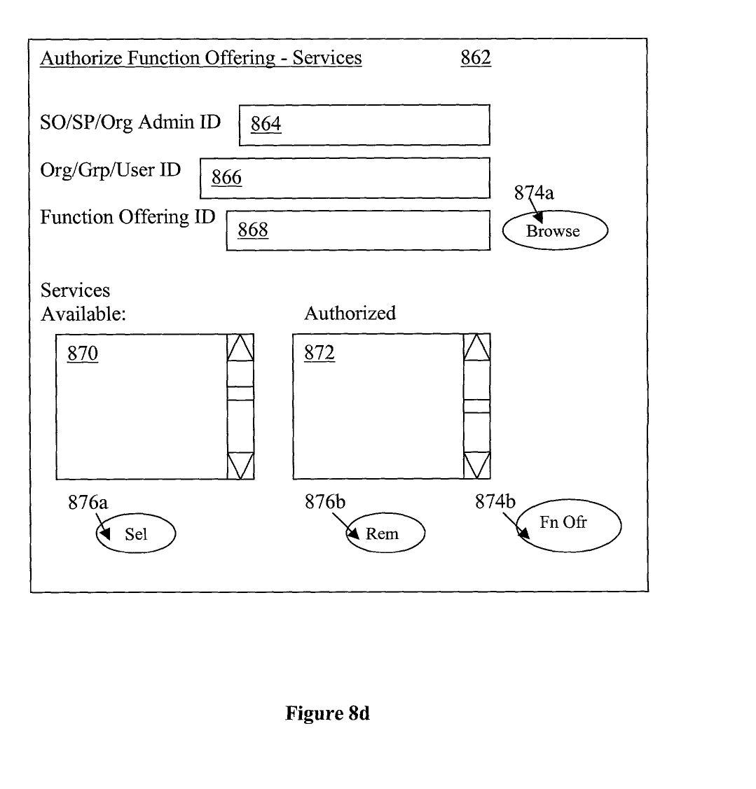

FIGS. 8a-8d illustrate four panes of an end user interface of FOM 108 suitable for use to practice the present invention, in accordance with one embodiment. As illustrated, for the embodiment, panes 802 is used to facilitate creation or update of a function offering, while pane 822 is used to facilitate creation or update of a service. Pane 842 on the other hand is used to authorize administration or access to function offerings, while pane 862 is used to authorize administration or access to services. For the embodiment, it is assumed that the function offering/service creating licensee administrator, and the function offering/service administration authorizing or access enabling administrator have successfully logged into the system (that is having been properly validated as an appropriate licensee administrator, organization administrator, or group administrator). Of course, in alternate embodiments, all the operations performed via the illustrative end user interface may be accomplished programmatically or via other approaches without the employment of an end user interface.

Pane 802 includes field 804 to reflect the identifier of the logged-in licensee administrator. Pane 802 further includes fields 806 and 808 and “add” and “del” buttons 814a and 816a for facilitating creation of a new function offering or selection of an existing function offering (the logged-in licensee administrator is authorized to manage) for update or delete. As the logged-in licensee administrator enters the name of a function offering in field 806, existing function offerings that match the portion of the name entered thus far are retrieved and displayed in field 808 (which becomes a scrollable list if the number of retrieved function offerings exceeds the amount of space available for display in field 808). If no function offering matches the name entered, field 808 remains empty. The logged-in licensee administrator may “click” on “add” button 814a to have a function offering of the name entered created (its contents remain to be defined). On the other hand, if function offerings matching the name segment entered exist, as alluded to earlier, the names/identifiers of the matching function offerings are displayed in field 808. The logged-in licensee administrator may then select one of the displayed function offering for update or delete. Upon selection, e.g. by “clicking” on a displayed function offering, the name/identifier of the selected function offering is echoed in field 806. The licensee administrator may delete the selected function offering by “clicking” on “del” button 816a.

Pane 802 further includes scrollable fields 810 and 812 and “add” and “del” buttons 814b and 816b for facilitating association or update of services associated with the selected function offering. Scrollable field 812 lists all services available to the licensee administrator to associate with a function offering (i.e. all authorized services with the scope of the administrator'), while scrollable field 810 lists all services associated with the selected function offering. By selecting any of the listed available or associated services, and “clicking” on “sel” (select) and “rem” (remove) buttons 814b and 816b, the licensee administrator may associate an available service with the selected function offering, or remove an associated service from the selected function offering. Lastly, pane 802 includes button 818 for the logged-in licensee administrator to switch to pane 822 to create a new service or update an existing service.

As illustrated, pane 822 includes field 824 to reflect the identifier of the logged-in licensee administrator. Pane 822 further includes fields 826 and 828 and “add” and “del” buttons 834a and 836a for facilitating creation of a new service or selection of an existing service (the logged-in licensee administrator is authorized to manage) for update or delete. As the logged-in licensee administrator enters the name of a service in field 826, existing services that match the portion of the name entered thus far are retrieved and displayed in field 828 (which becomes a scrollable list if the number of retrieved services exceeds the amount of space available for display in field 828). If no service matches the name entered, field 828 remains empty. The logged-in licensee administrator may “click” on “add” button 834a to have a service of the name entered created (its contents remain to be defined). On the other hand, if services matching the name segment entered exist, as alluded to earlier, the names/identifiers of the matching services are displayed in field 808. The logged-in licensee administrator may then select one of the displayed services for update or delete. Upon selection, e.g. by “clicking” on a displayed service, the name/identifier of the selected service is echoed in field 826. The licensee administrator may delete the selected service by “clicking” on “del” button 836a.

Pane 822 further includes scrollable fields 830 and 832 and “add” and “del” buttons 834b and 836b for facilitating association or update of service components associated with the selected service. Scrollable field 832 lists all service components available to the licensee administrator to associate with a service (i.e. all authorized service components), while scrollable field 830 lists all service components associated with the selected service. By selecting any of the listed available or associated services, and “clicking” on “sel” (select) and “rem” (remove) buttons 814b and 816b, the licensee administrator may associate an available service component with the selected service, or remove an associated service component from the selected service.

In one embodiment, pane 822 also includes like features (not specifically shown) to facilitate an administrator of a licensee organization in creating or updating data publications, designating selected ones of the licensed service components as publishing components of the data publications.

Similar to pane 802, pane 822 also includes button 838 for the logged-in licensee administrator to switch to pane 802 to create a new function offering or update an existing function offering. Accordingly, using buttons 818 and 838, a licensee administrator may switch back and forth between panes 802 and 822, creating and updating function offerings as well as services, in particular, the function offerings' constituting services.

Pane 842 includes field 844 to reflect the identifier of the logged-in licensee, organization or group administrator. Pane 842 further includes field 846 and “browse” button 826 for facilitating selection of an organization, group or user identifier, within the scope of the logged-in administrator's authority for function offering/service administration. The logged-in administrator may directly enter the organization/group/user identifier to be administered into field 846, or “click” on “browse” button 856a to list organization and group administrators as well as end users within the logged-in administrator's administration scope, and select an administration subject from the list. Pane 842 further includes scrollable fields 850 and 852, as well as “sel” (select) and “del” (delete) buttons 858a and 858b for authorizing function offerings within the administration scope of the logged-in administrator to the administration subject, or removing authorized function offerings of the administration subject. Scrollable field 850 lists all available function offerings, while scrollable field 852 lists all authorized function offerings. Button 858a authorizes a selected available function offering, while button 858b removes a selected authorized function offering. For the illustrated embodiment, authorization of a function offering automatically authorizes all constituting services of the authorized function offering, unless specific actions are taken to revoke the authorization given for some of the constituting services. Lastly, pane 842 includes button 856b for facilitating the logged-in administrator to switch on pane 862 to authorize access at the service level instead (as opposed to the described function offering level).

In one embodiment, pane 862 also includes like features (not specifically shown) to facilitate an administrator of a licensee organization in selecting and authorizing data publications of the licensee organization and data publications of other organizations for subscription by users authorized as shared data subscribers.

Similar to pane 842, pane 862 includes fields 864 and 866 to reflect the identifier of the logged-in administrator and the identifier of the administration subject. Pane 862 further includes field 868 and “browse” button 874a for facilitating selection of a function offering, within the scope of the logged-in administrator's authority for service level administration. The logged-in administrator may directly enter the function offering identifier into field 868, or “click” on “browse”button 874a to list the function offerings within the logged-in administrator's administration scope, and select a function offering from the list. Pane 862 further includes scrollable fields 872 and 870, as well as “del” (delete) and “sel” (select) buttons 876b and 876a for removing authorized services of the selected function offering, and re-authorizing services of the selected function offering. Scrollable field 872 lists all authorized services of the function offering, while scrollable field 870 lists all services of the function offering available for authorization. Button 876b removes a selected authorized service of the function offering, while button 876a re-authorizes a selected available service of the function offering. Lastly, pane 862 includes button 874b for facilitating the logged-in administrator to go to pane 842 to authorize access at the function offering level. Accordingly, using buttons 856b and 874b, an administrator may switch back and forth between panes 842 and 862, authorizing and de-authorizing function offerings as well as services for selected administration subjects.

In alternate embodiments, other interface features as well as interfaces of other designs may be used instead to practice the present invention.

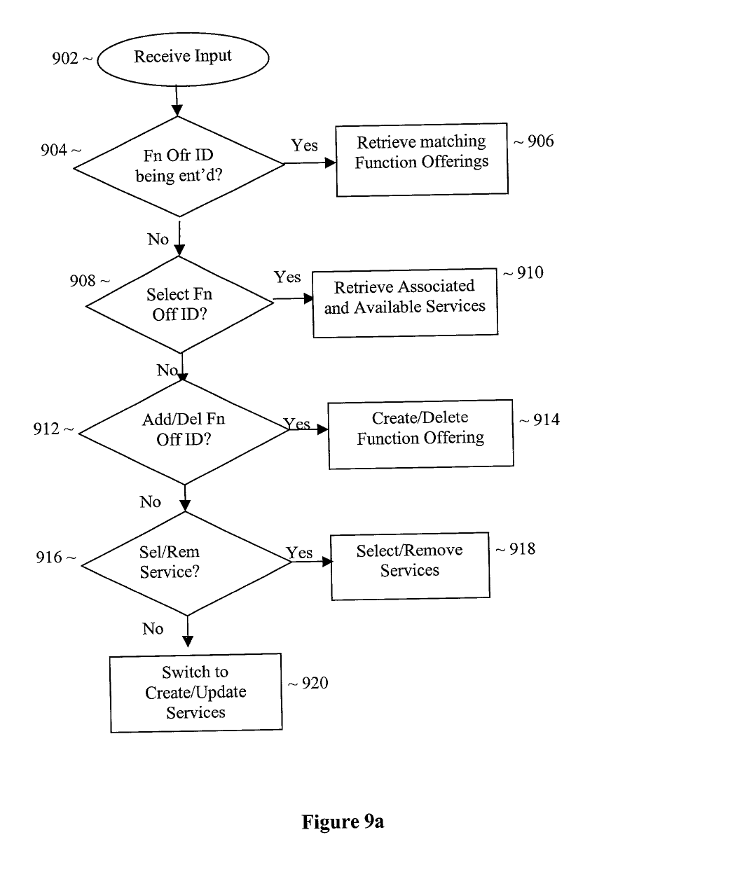

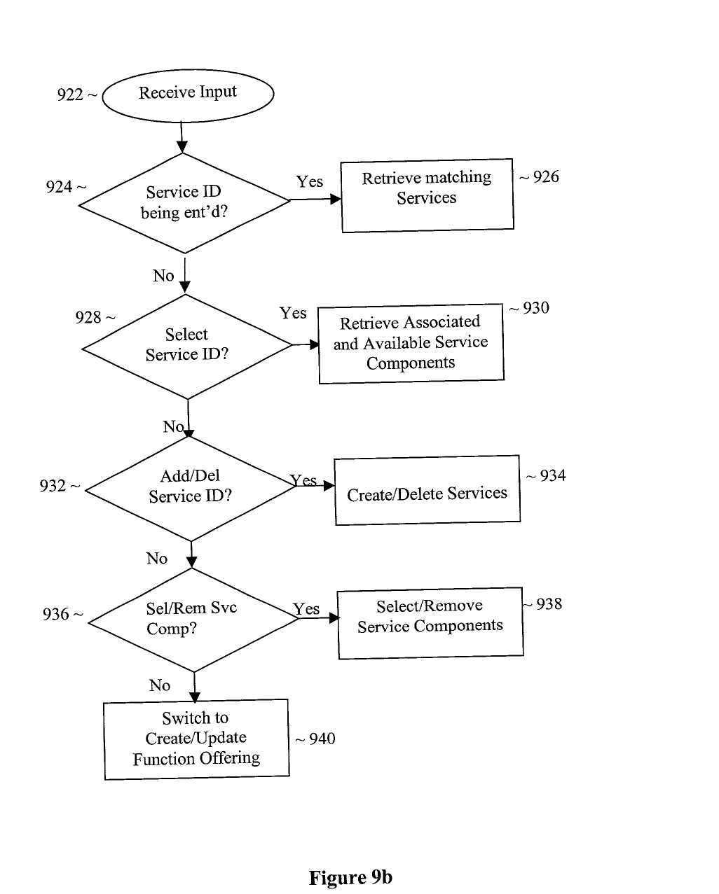

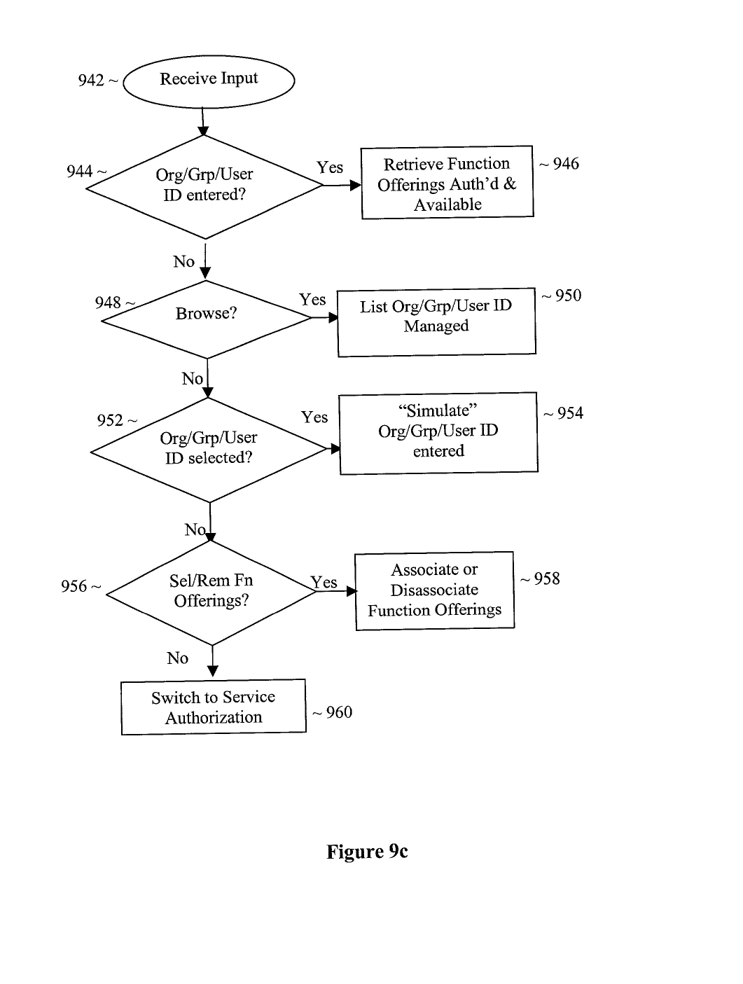

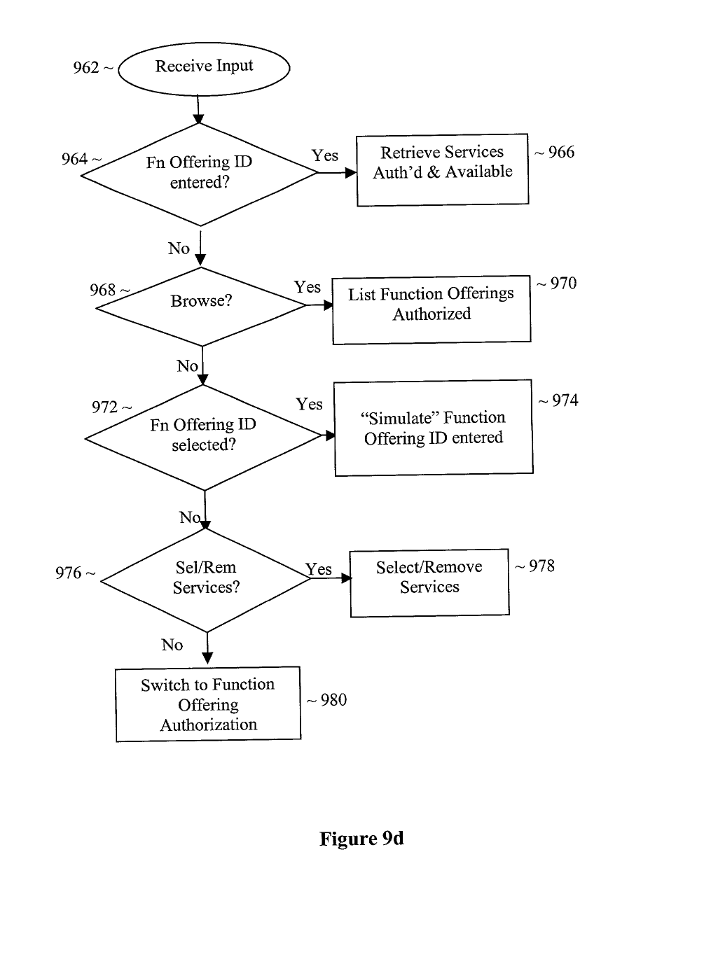

FIGS. 9a-9d illustrate the relevant operational flow of FOM 108 for practicing the present invention, in accordance with one embodiment. More specifically, FIG. 9a illustrates the relevant operational flow for creating/updating a function offering, whereas FIG. 9b illustrates the relevant operational flow for creating/updating a service of a function offering. FIG. 9c illustrates the relevant operational flow for authorizing administration or enabling access to function offerings, whereas FIG. 9d illustrates the relevant operational flow for authorizing administration or enabling access to services of a function offering.

As illustrated in FIG. 9a, for the embodiment, upon receipt of an event notification associated with the function offering creation/update interface (hereinafter, simply “request”), block 902, FOM 108 determines if the request is associated with a function offering identifier being entered, block 904. If so, FOM 108 retrieves and displays the matching function offerings, block 906. If not, FOM 108 continues at block 908.

At block 908, FOM 108 determines if the request is associated with the selection of a displayed function offering. If so, FOM 108 retrieves the associated services of the selected function offering as well as the services within the scope of the administrator's administration available for association with the selected function offering, block 910. If not, FOM 108 continues at block 912.

At block 912, FOM 108 determines if the request is associated with the addition or deletion of a function offering. If so, FOM 108 creates the newly named function offering or deletes the selected function offering accordingly, block 914. If not, FOM 108 continues at block 916.

At block 916, FOM 108 determines if the request is associated with the selection of a service to be associated with the selected function offering or the removal of an associated service from the selected function offering. If so, FOM 108 associates or disassociates the selected service with the selected function offering accordingly, block 918. If not, for the illustrated embodiment, the request is inferred to be a request to switch to the create/update service pane. Accordingly, FOM 108 switches the create/update service pane and transfers control to its associated logic, block 920.

Similarly, as illustrated in FIG. 9b, for the embodiment, upon receipt of an event notification associated with the service creation/update interface (hereinafter, simply “request”), block 922, FOM 108 determines if the request is associated with a service identifier being entered, block 924. If so, FOM 108 retrieves and displays the matching services, block 926. If not, FOM 108 continues at block 928.

At block 928, FOM 108 determines if the request is associated with the selection of a displayed service. If so, FOM 108 retrieves the associated service components of the selected service as well as the service components within the scope of the administrator's administration available for association with the selected service, block 930. If not, FOM 108 continues at block 932.

At block 932, FOM 108 determines if the request is associated with the addition of deletion of a service. If so, FOM 108 creates the newly named service or deletes the selected service accordingly, block 934. If not, FOM 108 continues at block 936.

At block 936, FOM 108 determines if the request is associated with the selection of a service component to be associated with the selected service or the removal of an associated service component from the selected service. If so, FOM 108 associates or disassociates the selected service component with the selected service accordingly, block 938. If not, for the illustrated embodiment, the request is inferred to be a request to switch to the create/update function offering pane. Accordingly, FOM 108 switches the create/update function offering pane and transfers control to its associated logic, block 940.

In one embodiment where creation of data publications for data sharing is supported, instead of inferring a request as a request to switch to the create/update function offering pane, upon determining that the request is not associated with the association/disassociation of the selected service component with the selected service, FOM 108 determines if the request is associated with the creation of a data publication instead. If so, FOM 108 facilitates the creation of the data publication, including assignment of a publication identifier. If not, FOM 108 then infers the request as being associated with switching to the create/update function offering pane, and handles the request accordingly, as described earlier.

As illustrated in FIG. 9c, for the embodiment, upon receipt of an event notification associated with the function offering authorization/enabling interface (hereinafter, simply “request”), block 942, FOM 108 determines if the request is associated with an organization, group or user identifier being entered, block 944. If so, FOM 108 retrieves function offerings already authorized for the organization/group administrator or user, and function offerings within the scope of the administrator's administration available for authorization , block 946. If not, FOM 108 continues at block 948.

At block 948, FOM 108 determines if the request is associated with listing organization/group administrator and user identifiers within the scope of the administrator's administration. If so, FOM 108 retrieves and displays their identifiers, block 950. If not, FOM 108 continues at block 952.

At block 952, FOM 108 determines if the request is associated with the selection of an organization/group administrator or user identifier. If so, FOM 108 “simulates” entry of the selected identifier, block 954. If not, FOM 108 continues at block 956.

At block 956, FOM 108 determines if the request is associated with the selection of a function offering for authorization or selection of an authorized function offering for de-authorization. If so, FOM 108 authorizes or de-authorizes the selected function offering accordingly, block 958. If not, for the illustrated embodiment, the request is inferred to be a request to switch to service authorization. Accordingly, FOM 108 switches to the service authorization pane, and transfers control to its associated logic accordingly, block 960.

As illustrated in FIG. 9d, for the embodiment, upon receipt of an event notification associated with the service authorization/enabling interface (hereinafter, simply “request”), block 962, FOM 108 determines if the request is associated with a function offering identifier being entered, block 944. If so, FOM 108 retrieves services of the function offering already authorized for the organization/group administrator or user, and other services of the function offering within the scope of the administrator's administration available for authorization, block 966. If not, FOM 108 continues at block 968.

At block 968, FOM 108 determines if the request is associated with listing the function offerings within the scope of the administrator's administration. If so, FOM 108 retrieves and displays their identifiers, block 970. If not, FOM 108 continues at block 972.

At block 972, FOM 108 determines if the request is associated with the selection of a function offering. If so, FOM 108 “simulates” entry of the selected function offering's identifier, block 974. If not, FOM 108 continues at block 976.

At block 976, FOM 108 determines if the request is associated with the selection of a service for authorization or selection of an authorized service for de-authorization. If so, FOM 108 authorizes or de-authorizes the selected service of the function offering accordingly, block 958. If not, for the illustrated embodiment, the request is inferred to be a request to switch to function offering authorization. Accordingly, FOM 108 switches to the function offering authorization pane, and transfers control to its associated logic accordingly, block 960.

In one embodiment where subscription of data publications for data sharing is supported, instead of inferring a request as a request to switch to the function offering authorization pane, upon determining that the request is not associated with the authorization/de-authorization of the selected service of the function offering, FOM 108 determines if the request is associated with the authorization of a data publication instead. If so, FOM 108 facilitates the authorization of the data publication for subscription. If not, FOM 108 then infers the request as being associated with switching to the function offering authorization pane, and handles the request accordingly, as described earlier.

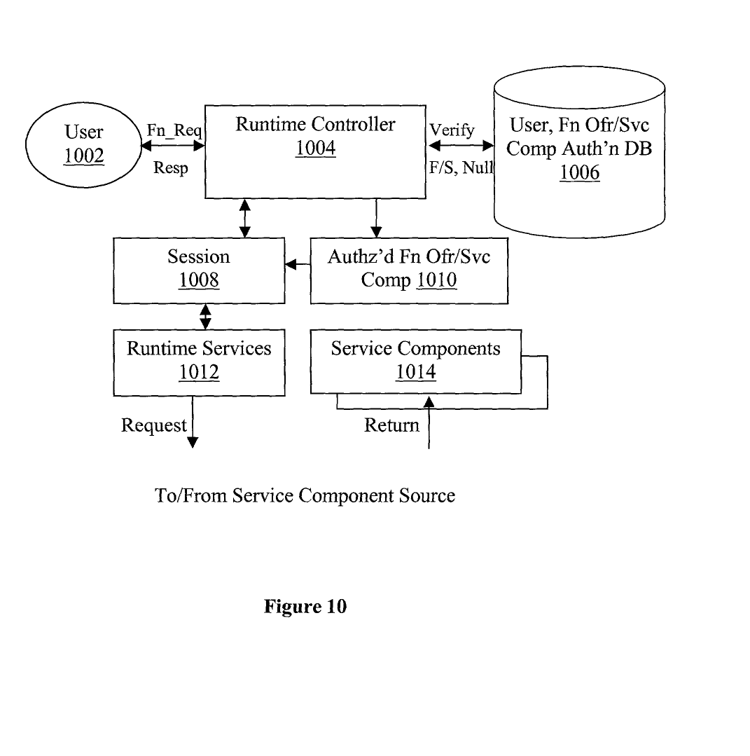

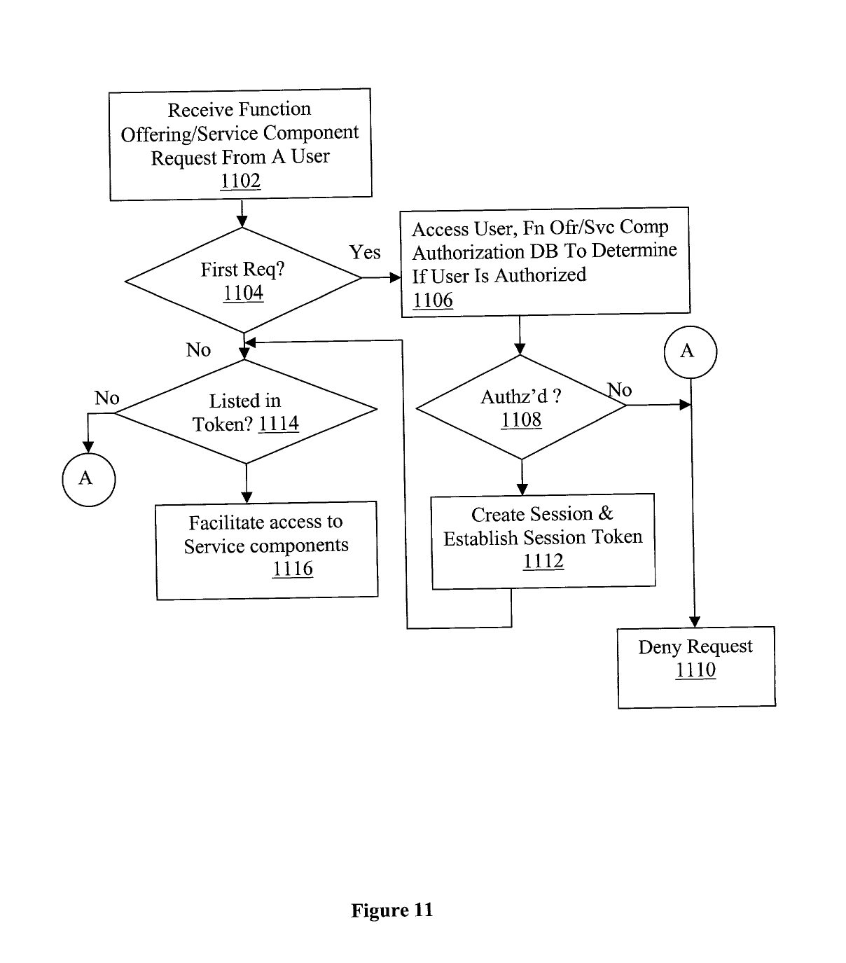

FIGS. 10 and 11 illustrate an overview of a function offering or service launching method of the present invention, in accordance with one embodiment. As illustrated, user 1002 submits a function request (Fn_Req) to runtime controller 1004 (same as runtime controller 104 of FIG. 1) (block 1102). In response, runtime controller 1004 determines if this is the first request from user 1002, i.e. whether a session environment has previously been created for requesting user 1002 (block 1104). If the request is the first request and the session environment is yet to be created, runtime controller 1004 accesses users and function offerings/services authorization database 1008 to verify user 1002 is “enabled”, i.e. authorized to access at least one service or function offering (blocks 1106 and 1108). In one embodiment, if user is “enabled”, runtime controller 1004 also accesses users and function offerings/services authorization database 1008 to determine if the user is an eligible shared data subscriber, and if so, his/her subscriptions, if any. Users and function offerings/services authorization database 1008 includes a data organization having user, function offering/service authorization and enabling information similar to the data organization earlier described referencing FIG. 7, and components 110 having security properties 342 as earlier described referencing FIG. 3c. Further, in an embodiment where data sharing through publication and subscription as earlier described is supported, database 1008 further includes data publications and data subscriptions of the subscriber users.

If user 1002 is not “enabled” (authorized) to access at least one service or function offering, the request is rejected or denied (block 1110). If user 1002 is “enabled” (authorized) to access at least one service or function offering, runtime controller 1004 establishes a session environment 1008 for the user, instantiates various runtime services 1012 for the session 1008, retrieves a token 1010 listing all the authorized function offerings and services of the user, and associates token 1010 with session 1008 (block 1112). In an embodiment where data sharing through publication and subscription as earlier described is supported, token 1010 further includes identification of data managed by publishing components of the user's subscribed data publications, if any. For the earlier described publication and subscription approach, applicable ones of the data managed by publishing components are resolved through the publication identifier properties of the publishing components and the subscribed data publications.

Upon doing so, or earlier determining that the request is not a first request, and such a session environment had been previously established for the user, runtime controller 1004 transfers the request to an appropriate runtime service to handle. Thereafter, runtime services 1012 retrieve and instantiate the appropriate service components or objects associated with the requested service or applicable services associated with the requested function offering 1014 in accordance with whether the requested services/function offerings are among the authorized ones listed in token 1010 created for the session 1008. Further, during execution, the user is conditionally given access to use the earlier described Get, Put, and Execute method associated with the “authorized” service components, depending on whether the user has been given the right to access these methods (blocks 1114-1116). Recall a non-user owner is implicitly given the right to use these methods, for being a member of an authorized user group of the user owner, or a fellow user of the authorized organization/enterprise of the user owner. Alternatively, the non-user owner may have been implicitly given the right to use these methods because the user owner has granted access right to an universal data sharing entity (such as “world”).

Moreover, in an embodiment where data sharing through publication and subscription as earlier described is supported, the user is conditionally given access to data managed by the authorized service components as well as data managed by the publishing components of the subscribed data publications.

Contributor users contribute to data managed by the publishing components of the data publications the users are so designated, by accessing and modifying these data. Contributor users are conditionally given access to these components and data in like manner as subscriber users are conditionally given access, as earlier described.

Runtime services 1012 are intended to represent a broad range of runtime services, including but are not limited to memory allocation services, program loading and initialization services, certain database or data structure interfacing functions, and so forth. In alternate embodiments, security token 1010 may be statically pre-generated and/or dynamically updated to reflect dynamic changes in publications and subscriptions.

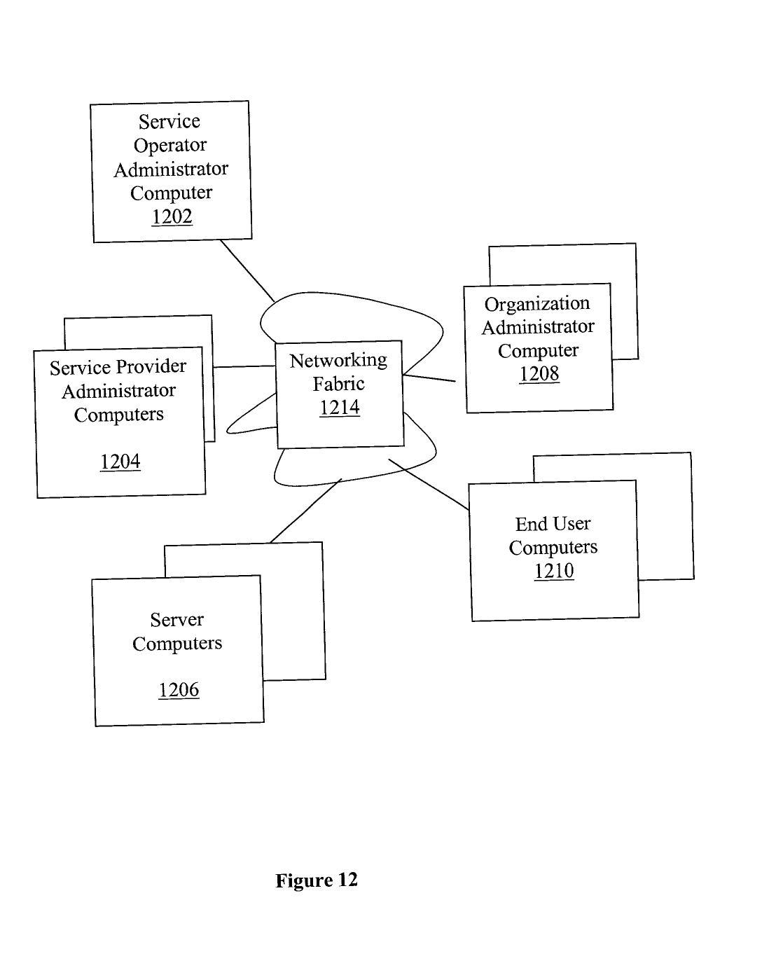

FIG. 12 illustrates a network environment suitable for practicing the present invention. As illustrated, network environment 1200 includes service operator administrator computer 1202, service provider administrator computers 1204, server computers 1206, organization administrator computers 1208, and end user computers 1210. The computers are coupled to each other through networking fabric 1214.

Server computers 1206 are equipped with the earlier described multi-function application 100 including administration tool 102 and runtime controller 104. In selected implementations, all or part of ACM 106 and FOM 108 are instantiated onto the respective computers 1202-1204 and 1208-1210 for execution. Similarly, for selected ones of function offerings 114, services 112, packages 111 or service components 110, all or part of these offerings, services, packages or service components are invoked by end user computers 1212 for execution.

In one embodiment, service operator administrator computer 1202, service provider administrator computers 1204 and server computer 1206 are affiliated with the vendor of application 100, while organization administrator computers 1208, and end user computers 1210 are affiliated with customers or service subscribers of application 100.

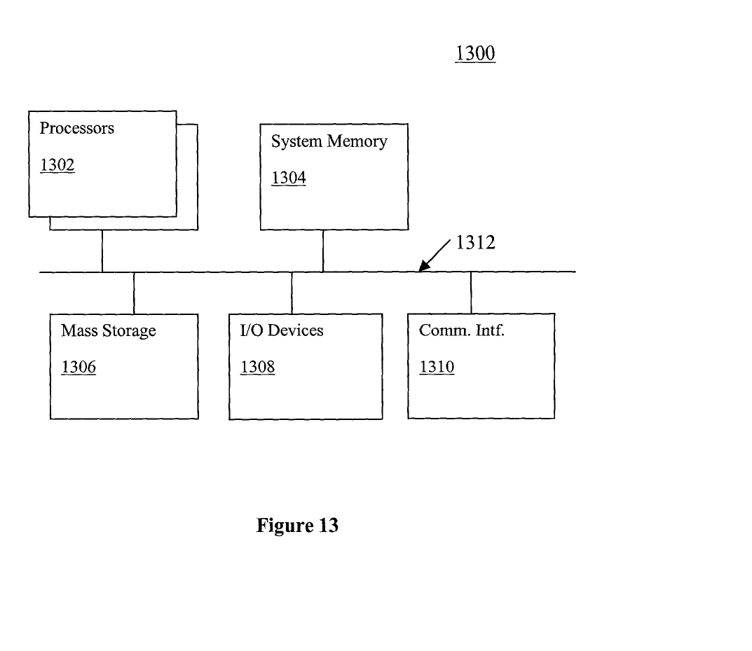

Computers 1202-1210 are intended to represent a broad range of computers known in the art, including general purpose as well as special purpose computers of all form factors, from palm sized, laptop, desk top to rack mounted. An example computer suitable for use is illustrated in FIG. 13. Networking fabric 1214 is intended to represent any combination of local and/or wide area networks, including the Internet, constituted with networking equipment, such as hubs, routers, switches as the like.

As alluded to earlier, FIG. 13 illustrates an example computer system suitable for use to practice the present invention. As illustrated, example computer system 1300 includes one or more processors 1302 (depending on whether computer system 1300 is used as server computer 1206 or other administrator/end user computers 1202-1204 and 1208-1210), and system memory 1304 coupled to each other via “bus” 1312. Coupled also to “bus” 1312 are non-volatile mass storage 1306, input/output (I/O) devices 1308 and communication interface 1314. During operation, memory 1304 includes working copies of programming instructions implementing teachings of the present invention.

Except for the teachings of the present invention incorporated, each of these elements is intended to represent a wide range of these devices known in the art, and perform its conventional functions. For example, processor 1302 may be a processor of the Pentium® family available from Intel Corporation of Santa Clara, CA, or a processor of the PowerPC® family available from IBM of Armonk, NY. Processor 1302 performs its conventional function of executing programming instructions, including those implementing the teachings of the present invention. System memory 1304 may be SDRAM, DRAM and the like, from semiconductor manufacturers such as Micron Technology of Boise, Id. Bus 1312 may be a single bus or a multiple bus implementation. In other words, bus 1312 may include multiple buses of identical or different kinds properly bridged, such as Local Bus, VESA, ISA, EISA, PCI and the like.

Mass storage 1306 may be disk drives or CDROMs from manufacturers such as Seagate Technology of Santa Cruz of Calif., and the like. Typically, mass storage 1306 includes the permanent copy of the applicable portions of the programming instructions implementing the various teachings of the present invention. The permanent copy may be installed in the factory, or in the field, through download or distribution medium. I/O devices 1308 may include monitors of any types from manufacturers such as Viewsonic of City, State, and cursor control devices, such as a mouse, a track ball and the like, from manufacturers such as Logictech of Milpitas, Calif. Communication interface 1310 may be a modem interface, an ISDN adapter, a DSL interface, an Ethernet or Token ring network interface and the like, from manufacturers such as 3COM of San Jose, Calif.

Thus, a method and an apparatus for managing and administering licensing of multi-function offering applications have been described. While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. A data sharing method comprising:
designating a first user as an eligible shared data contributor;
designating an authorized service component of said eligible shared data contributor as a shared data publishing component;
defining a data publication;
tagging data managed by said publishing component for inclusion in said data publication;
designating a second user as an eligible shared data subscriber;
associating said second user as a subscriber of said data publication;
contributing to said data managed by said publishing component by said shared data contributor; and
facilitating access to said data managed by said publishing component based on said second user's subscription to said data publication, with which said said managed by said publishing component is tagged for inclusion.

2. The method of claim 1, wherein said defining comprises assigning a publication identifier for said data publication, and said tagging comprises assigning said assigned publication identifier to a component property of said publishing component.

3. The method of claim 1, wherein said method further comprises designating said data publication as a data publication available for subscription by eligible shared data subscribers of an organization, of which said second user is a member.

4. The method of claim 3, wherein said first user is also a member of said organization.

5. The method of claim 3, wherein said first user is not a member of said organization.

6. The method of claim 1, wherein said method further comprises determining data said second user is authorized to access when initialing a session environment for said user or when instantiating a requested component, and said determining includes resolving said second user's subscription of said data publication to said publishing component.

7. The method of claim 6, wherein said defining comprises assigning a publication identifier for said data publication, and said tagging comprises assigning said assigned publication identifier to a component property of said publishing component, and said resolution is made through said publication identifier.

8. A data sharing method comprising:
designating a user as an eligible shared data contributor;
designating an authorized service component of said eligible shared data contributor as a shared data publishing component;
defining a data publication;
tagging data managed by said publishing component for inclusion in said data publication to facilitate sharing of data managed by said publishing component with other users through said other users' subscription to said data publication; and
contributing to said data managed by said publishing component by said shared data contributor.

9. The method of claim 8, wherein said defining comprises assigning a publication identifier for said data publication, and said tagging comprises assigning said assigned publication identifier to a component property of said publishing component.

10. A data sharing method comprising:
designating a user as an eligible shared data subscriber;
associating said user as a subscriber of a data publication including data managed by a publishing component; and
facilitating access to said data managed by said publishing component based on said user's subscription to said data publication, with which said data managed by said publishing component is tagged for inclusion.

11. The method of claim 10, wherein said user is a member of an organization, and said method further comprises designating said data publication as available for subscription by eligible shared data subscriber users of said organization.

12. The method of claim 10, wherein said method further comprises determining data said user is authorized to access when initialing a session environment for said user or when instantiating a requested component, and said determining includes resolving said user's subscription of said data publication to said publishing component.

13. The method of claim 12, wherein said data publication is assigned a publication identifier and a property of said service component is also assigned with said publication identifier; further, said resolution is made through said publication identifier.

14. An apparatus comprising:
storage medium having stored therein a plurality of programming instructions designed to facilitate
designation of a user as an eligible shared data contributor,
designation of an authorized service component of said eligible shared data contributor as a shared data publishing component,
definition of a data publication,
tagging of data managed by said publishing component for inclusion in said data publication to facilitate sharing of data managed by said publishing component with other users through said other users' subscription to said data publication, and
contribution to said data managed by said publishing component by said shared data contributor; and
one or more processors coupled to said storage medium to execute said programming instructions.

15. The apparatus of claim 14, wherein said programming instructions are designed to facilitate said definition of a data publication by assigning a publication identifier for said data publication, and said tagging by assigning said assigned publication identifier to a component property of said publishing component.

16. An apparatus comprising:
storage medium having stored therein a plurality of programming instructions designed to facilitate
designation of a user as an eligible shared data subscriber,
association of said user as a subscriber of a data publication including data managed by said publishing component, and
access to said data managed by said publishing component based on said user's subscription to said data publication, with which said data managed by said publishing component is tagged for inclusion; and
one or more processors coupled to the storage medium to execute the programming instructions.

17. The apparatus of claim 16, wherein said user is a member of an organization, and said programming instructions are further designed to facilitate designation of said data publication as available for subscription by eligible shared data subscriber users of said organization.

18. The apparatus of claim 16, wherein said programming instructions are further designed to determine data said user is authorized to access when initialing a session environment for said user or instantiating a requested component, including resolution of said user's subscription of said data publication to said publishing component.

19. The apparatus of claim 18, wherein said programming instructions are further designed to assign said data publication a publication identifier, and assign the same publication identification to a property of said service component; further, to perform said resolution through said publication identifier.

20. An apparatus comprising:
storage medium having stored therein a plurality of programming instructions designed to facilitate
designation of a user as an eligible shared data contributor,
designation of an authorized service component of said eligible shared data contributor as a shared data publishing component,
defining a data publication
tagging data managed by said publishing component for inclusion with said data publication,
designation of a user as an eligible shared data subscriber,
association of said user as a subscriber of a data publication,
contribution to data managed by said publishing component by said associated shared data contributor, and
access to said data managed by said publishing component based on said user's subscription to said data publication, with which said data managed by said publishing component is tagged for inclusion; and
one or more processors coupled to said storage medium to execute said programming instructions.

21. A data sharing method comprising:
facilitating authorization of members of a plurality of data sharing entities to access a plurality of methods of a service component by a first user; and
conditionally permitting a second user to invoke a first of said methods in accordance with whether said second user as a member of one of said plurality of data sharing entities is authorized to invoke said first method.

22. The method of claim 21, wherein said data sharing entities comprise a user group of which said first and second users are members, and said facilitating comprises facilitating implicit authorization of said second user, by said first user, to invoke said first method by authorizing all members of said user group to invoke said first method.

23. The method of claim 21, wherein said data sharing entities comprise an organization having one or more user groups, and said first user as well as said second user are members of said organization, further, said facilitating comprises facilitating implicit authorization of said second user, by said first user, to invoke said method by authorizing all members of said organization to invoke said method.

24. The method of claim 21, wherein said data sharing entities comprise an enterprise having one or more organizational units, and said first user as well as said second user are members of said enterprise, further, said facilitating comprises facilitating implicit authorization of said second user, by said first user, to invoke said method by authorizing all members of said enterprise to invoke said method.

25. The method of claim 21, wherein said data sharing entities comprise an universal data sharing entity of which said first user and said second user are members, said facilitating comprises facilitating implicit authorization of said second user, by said first user, to invoke said method by authorizing all members of said universal data sharing entity to invoke said method.

26. The method of claim 21, wherein said methods comprise at least a selected one of a method to obtain data, a method to store data, and a method to perform a predetermined execution using at least data managed by said component.

27. The method of claim 21, wherein said method further comprises said first user selectively authorizing himself/herself to perform one or more of invoking a first method of said component to obtain data, invoking a second method of said component to store data, and invoking a third method of said component to perform a predetermined execution using at least data managed by said component.

28. The method of claim 21, wherein said facilitating comprises determining a security property value representative of authorization given to said members of said data sharing entities.

29. The method of claim 28, wherein said determining comprises determining a binary representation for authorization given to members of one of said data sharing entities.

30. The method of claim 29, wherein said determining further comprises converting a binary representation representative of authorization given to members of one of said data sharing entities to a decimal representation.

31. The method of claim 30, wherein said determining further comprises concatenating a plurality of decimal representations to generate said security property value.

32. The method of claim 21, wherein said conditionally permitting comprises determining whether said second user is a member of said plurality of data sharing entities whose members have been authorized to share said data by said data contributor.

33. The method of claim 32, wherein said determining comprises examining a security property value representative of authorizations given to members of one or more data sharing entities.

34. An apparatus comprising:
storage medium having stored therein a plurality of programming instructions designed to
facilitate authorization of members of a plurality of data sharing entities to access a plurality of methods of a service component by a first user, and
conditionally permit a second user to invoke a first of said methods in accordance with whether said second user as a member of one of said plurality of data sharing entities is authorized to invoke said first method;
one or more processors coupled to said storage medium to execute said programming instructions.

35. The apparatus of claim 34, wherein said data sharing entities comprise a user group of which said first and second users are members, and said programming instructions are further designed to facilitate implicit authorization of said second user, by said first user, to invoke said first method by authorizing all members of said user group to invoke said first method.

36. The apparatus of claim 34, wherein said data sharing entities comprise an organization having one or more user groups, and said first user as well as said second user are members of said organization, further, said programming instructions are further designed to facilitate implicit authorization of said second user, by said first user, to invoke said method by authorizing all members of said organization to invoke said method.

37. The apparatus of claim 34, wherein said data sharing entities comprise an enterprise having one or more organizational units, and said first user as well as said second user are members of said enterprise, further, said programming instructions are further designed to facilitate implicit authorization of said second user, by said first user, to invoke said method by authorizing all members of said enterprise to invoke said method.

38. The apparatus of claim 34, wherein said data sharing entities comprise an universal data sharing entity of which said first user and said second user are members, said programming instructions are further designed to facilitate implicit authorization of said second user, by said first user, to invoke said method by authorizing all members of said universal data sharing entity to invoke said method.

39. The apparatus of claim 34, wherein said methods comprise at least a selected one of a method to obtain data, a method to store data, and a method to perform a predetermined execution using at least data managed by said component.

40. The apparatus of claim 34, wherein said programming instructions are further designed to facilitate said first user selectively authorizing himself/herself to perform one or more of invoking a first method of said component to obtain data, invoking a second method of said component to store data, and invoking a third method of said component to perform a predetermined execution using at least data managed by said component.

41. The apparatus of claim 34, wherein said programming instructions are further designed to determine a security property value representative of authorization given to said members of said data sharing entities.

42. The apparatus of claim 41, wherein said programming instructions are further designed to determine a binary representation for authorization given to members of one of said data sharing entities.

43. The apparatus of claim 42, wherein said programming instructions are further designed to facilitate converting a binary representation representative of authorization given to members of one of said data sharing entities to a decimal representation.

44. The apparatus of claim 43, wherein said programming instructions are further designed to concatenate a plurality of decimal representations to generate said security property value.

45. The apparatus of claim 34, wherein said programming instructions are further designed to determine whether said second user is a member of said plurality of data sharing entities whose members have been authorized to share said data by said data contributor.

46. The apparatus of claim 45, wherein said programming instructions are further designed to examine a security property value representative of authorizations given to members of one or more data sharing entities.
